(19) United States
(12) Patent Application Publication
(10) Pub. No.: US 2004/0013881 A1
(43) Pub. Date: Jan. 22, 2004

(54) Process for the production of an image transfer film and an image film

(76) Inventor: Markus Fritschi, Teufen (CH)

Correspondence Address: BACHMAN & LAPOINTE, P.C., 900 CHAPEL STREET, SUITE 1201, NEW HAVEN, CT, 06510, US

(21) Appl. No.: 10/465,740

(22) Filed: Jun. 18, 2003

(30) Foreign Application Priority Data
Jun. 27, 2002 (CH) 2002 1115/02

(51) Int. Cl. B32B 9/04

(52) U.S. Cl. 428/411.1

(57) ABSTRACT

In a process for the production of an image film for applying an image to a carrier, a backing layer is coated with a clear lacquer layer, and at least one image-forming toner substrate is applied to the lacquer layer. The lacquer layer and the toner substrate are covered with a layer of liquid adhesive. After the covering operation the adhesive layer is removed from the lacquer layer. During removal liquid adhesive is introduced into the toner substrate. An image film produced thereby affords a defined image upon image transfer.

### FIELD OF THE INVENTION

The invention concerns a process for the production of an image transfer film for the transfer of an image from the image transfer film on to an image carrier. The invention further concerns an image transfer film produced by the process.

### BACKGROUND OF THE INVENTION

An image transfer process for supplying an image to the carrier such as an article to be decorated with the image can be in the form of a dry transfer process in which an image is transferred from an image transfer film, which will be hereinafter referred to for brevity as the image film, on to an image carrier, which can be referred to hereinafter for brevity as the carrier. That procedure does not provide that pigment dyes forming a pictorial, graphic or other representation are transferred as loose materials, which can be referred to hereinafter for brevity as toner substrate, as such, but rather the substrate is transferred together with the image film on to the carrier. The image film is then singly separated into individual image portions which remain on the carrier to form the image thereon, and image film residues which are pulled off the carrier. That purpose can be accomplished by an image film which in the form of a laminate includes a backing layer, a layer of a clear lacquer which is applied to the backing layer, toner substrate corresponding to images on the clear lacquer layer and a layer of an adhesive which covers the toner substrate and the clear lacquer layer. That laminate is brought into engagement with the carrier by way of the adhesive layer, for example by pressure and heat. That operation involves the formation of a rupture location which extends around the periphery of the surface of the substrate and which is perpendicular to the adhesive layer and which continues into the clear lacquer layer. The rupture location is formed because the toner substrate with the covering adhesive layer projects from the laminate consisting of the backing layer, the clear lacquer layer and the adhesive layer covering the clear lacquer layer. The adhesion forces are so set that the adhesion between the adhesive layer and the substrate and the clear lacquer layer is greater than the adhesion between the clear lacquer layer and the backing layer. After the image film has been brought into engagement with the carrier, and fixed thereon by the adhesive, the next production step is individually separating the image film disposed on the substrate into image portions and image film residues by the image film being pulled off the carrier again. In that operation the image film is separated by tearing along the rupture locations and, because of the difference in adhesion, the backing layer comes away from the clear lacquer layer over the substrate so that what remains on the carrier, viewed from the latter, are the adhesive layer, the substrate and the clear lacquer layer covering over the substrate, while the remainder of the carrier surface is free, that is to say not covered by image film. That separation operation, that is to say detaching image portions out of the image film, is generally referred to as ‘selective release’ or also ‘weeding’ as a synonym therefor. Both terms characterise removal of the remains of the image film along given rupture locations, in the adhesive layer, the substrate and the clear lacquer layer. It will be noted in this respect that delamination of image film layers, for example the backing layer from the clear lacquer layer, is not covered by the term ‘weeding’. The above-discussed image film suffers from the disadvantage that in the selective release operation it sometimes happens that the remains of the image film do not release satisfactorily along the peripherally extending rupture line of the adhesive layer of the image portion so that this layer remains on the carrier, and that appears in the form of misprints which are not acceptable having regard to commercial production speeds without individual object inspection steps.

### SUMMARY OF THE INVENTION

The object of the invention is that of developing a process for the production of an image transfer film, which avoids defective separation involving individualisation of the image film into image portions to be affixed to a carrier and image film remains to be detached therefrom.

A further object of the invention is to provide an image transfer film which can provide for ready separation into image portions destined to be secured on a carrier and image film residues to be removed therefrom to define the image on the carrier.

The foregoing and other objects are attained by a production process according to the invention for the production of an image transfer film for the transfer of an image from the film on to an image carrier, including coating a backing layer with a clear lacquer layer and applying toner substrates forming images on to the clear lacquer layer. The clear lacquer layer and the toner substrates are covered with an adhesive layer of liquid adhesive. Subsequently to the adhesive layer covering operation the adhesive layer is removed from the clear lacquer layer and during the removal operation liquid adhesive is introduced into the toner substrates.

In the image film aspect the foregoing and other objects are attained by an image film comprising a backing layer, a clear lacquer layer applied to the backing layer, and toner substrates on the clear lacquer. Adhesive is introduced in the toner substrates.

As will be seen from the embodiment of the invention described hereinafter the invention deviates from the prevailing practice in that, when glueing an image film to a carrier, adhesive is made available only in accordance with the geometrical configurations of the image parts of the image film, that is to say corresponding to those of the toner substrates, insofar as the substrates liberate amounts of adhesive accommodated in them at the time of the glueing operation or the coating operation. That ‘sectorial’ liberation renders the rupture lines known from the state of the art redundant so that selective release with the problems that it entails is circumvented with an increase in production certainty and reliability. The image applied in that way is clearly defined.

Further objects, features and advantages of the invention will be apparent from the description hereinafter of a preferred embodiment.

### BRIEF DESCRIPTION OF THE DRAWINGS

FIG. 1 is a view in longitudinal section of an image film, and

FIG. 2 shows a carrier to which the image film is to be applied and the image film prior to application to the carrier.

### DESCRIPTION OF THE PREFERRED EMBODIMENT

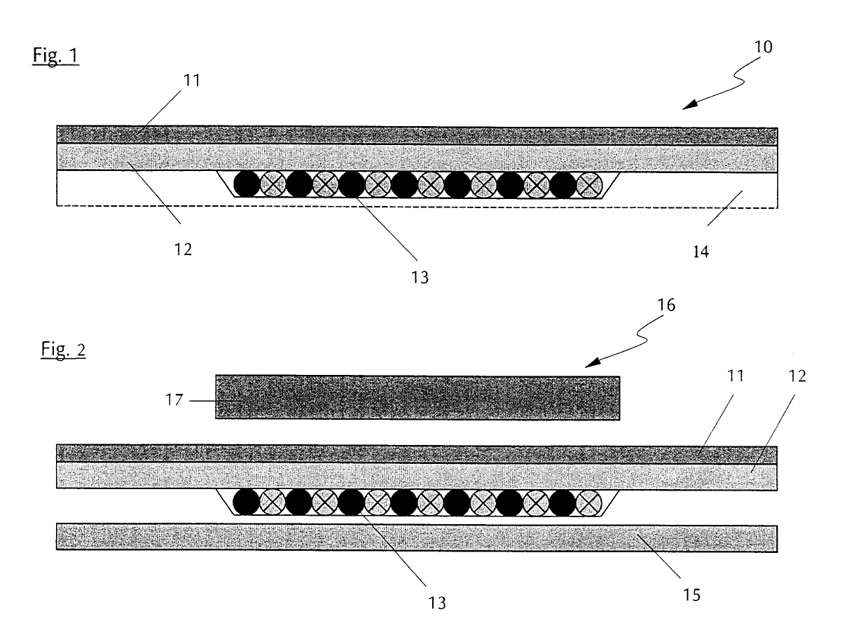

Referring to FIG. 1 an image film 10 according to the invention includes a backing layer 11, a clear lacquer layer 12 applied thereto, and toner substrates 13 representing print images, only one toner substrate being shown. The backing layer 11 is coated with the clear lacquer layer 12 using conventional procedures. The backing layer 11 is preferably a film, preferably a polyester or a smooth-coated paper, of a thickness of between 20 and 50 μm, preferably a thickness of between 23 and 26 μm. The clear lacquer layer 12 applied to the backing layer 11 is formed from an acrylic lacquer. That acrylic lacquer is mixed with a release agent which promotes release of the backing layer 11 from the clear lacquer layer 12 after the printing operation has been effected. The release agent is preferably a vaporisable wax which is added to the acrylic lacquer of the clear lacquer layer 12 in proportions by weight of between 20% and 5%, preferably between 2.5% and 3.5%. The printing operation is effected with the application of heat and pressure, the heat introduced into the image film 10 causing the wax to vaporise.

The print images, that is to say the toner substrates 13 representing print images, are applied to the clear lacquer layer 11. The operation of applying the substrate 13 is preferably effected by computer-controlled printers which in accordance with a program or specification stored in an EDP (computer) apparatus, provide for the deposit of toner particles in accordance with color, amount and the region of the print image. The substrate 13 is applied in such a way that the image surface of the substrate, which is intended to be viewed, is in engagement with the clear lacquer layer 12.

After application of the one or more substrates 13 a surface 12a carrying one or more substrates 13 is covered over its entire area with an adhesive layer 14 which also covers substrates 13 and which is then removed again over its entire area, except adhesive introduced into substrates 13. The steps of applying and removing the adhesive layer 14 are effected by squeegee-like coating bars which, with the coating-application and coating-removal device operating in the same direction, successively withdraw liquid adhesive from a storage container in order then after the coating operation to return it as such to a receiving container.

The toner substrate 13 is characterised by a higher degree of roughness and porosity than the clear lacquer layer 11, the consequence thereof being that, upon removal of the adhesive layer 14 which is applied over the full surface area, adhesive of that layer is introduced into the toner substrate 13 in the form of an adhesive agent supply which remains and is available there. The adhesive is applied and then removed in a molten condition at elevated temperature, that is to say at a temperature of between 100° C. and 140° C., preferably between 120° C. and 130° C., wherein the adhesive accommodated in the substrate then cools down and can solidify.

Upon application of the image film 10 to a carrier 15 the adhesive can liquefy again for adhesive purposes as a consequence of the heat which is applied in that operation, and then harden.

FIG. 2 is a view in diagrammatic form of an apparatus 16 for applying an image film 10 to a carrier 15, for example a Compact Disc. FIG. 2 shows the carrier 15 and a pressing member 17, preferably of silicone, between which the image film 10 according to the invention is arranged. Prior to or during the application procedure the image film 10 is heated and joined to the carrier 15 by downward movement of the pressing member 17, insofar as the adhesive which is reactivated by the heating effect is expelled from the substrate 13.

The pressure necessary for making the join can also be applied to the image film 10 by a roller (not shown).

The pressures which the pressing member 17 or the roller have to apply are between 0.75 kg per mm² and 1.5 kg per mm², preferably between 1.0 kg per mm² and 1.2 kg per mm².

After the glueing operation the backing layer 11 is pulled off the clear lacquer layer 12 so that the adhesive and the substrate 13 with the clear lacquer layer 12 covering over the substrate 13 as a protective layer for the substrate 13 remain on the carrier 15.

It will be appreciated that the above-described embodiment of the invention has been set forth solely by way of example and illustration of the principles thereof and that various modifications and alterations may be made therein without thereby departing from the spirit and scope of the invention.

What is claimed is:

1. A process for the production of an image transfer film for the transfer of an image from the image transfer film on to an image carrier, including
coating a backing layer with a clear lacquer layer,
applying at least one toner substrate forming an image,
covering the clear lacquer layer and the toner substrate with an adhesive layer of liquid adhesive, and
subsequently to the covering operation removing the adhesive layer from the clear lacquer layer with the introduction of liquid adhesive into toner substrate during the removal operation.

2. A process as set forth in claim 1
wherein the backing layer is in the form of a film of polyester.

3. A process as set forth in claim 1
wherein a layer of acrylic lacquer is applied as the clear lacquer layer to the backing layer.

4. An image film comprising
a backing layer,
a clear lacquer layer applied to the backing layer,
at least one toner substrate applied to the clear lacquer layer, and
adhesive introduced into the toner substrate.

5. An image film as set forth in claim 4
wherein the backing layer is formed from a film of polyester.

6. An image film as set forth in claim 4
wherein the backing layer comprises smooth-coated paper.

7. An image film as set forth in claim 4
wherein the backing layer is of a thickness of between 20 and 50 μm.

8. An image film as set forth in claim 4
wherein the backing layer is of a thickness of between 23 and 26 μm.

9. An image film as set forth in claim 4
wherein the clear lacquer layer is formed from an acrylic lacquer.

10. An image film as set forth in claim 9 including
a separating agent added to the acrylic lacquer.

11. An image film as set forth in claim 10
wherein the separating agent is a vaporisable wax.

12. An image film as set forth in claim 11
wherein the separating agent is added to the acrylic lacquer in a proportion of between 2% and 5%.

13. An image film as set forth in claim 12
wherein the proportion of separating agent in the acrylic lacquer is between 2.5% and 3.5%.
